(19) United States
(12) Patent Application Publication
(10) Pub. No.: US 2009/0002469 A1
(43) Pub. Date: Jan. 1, 2009

(54) LIQUID EJECTING HEAD AND LIQUID EJECTING APPARATUS

(75) Inventors: Atsushi Imai, Suwa-shi (JP); Hiroshige Owaki, Okaya-shi (JP)

Correspondence Address: Workman Nydegger;1000 Eagle Gate Tower, 60 East South Temple, Salt Lake City, UT, 84111, US

(73) Assignee: SEIKO EPSON CORPORATION, Tokyo (JP)

(21) Appl. No.: 12/147,337

(22) Filed: Jun. 26, 2008

(30) Foreign Application Priority Data
Jun. 27, 2007 (JP) 2007-168807
Mar. 4, 2008 (JP) 2008-054156

(51) Int. Cl. B41J 2/175

(52) U.S. Cl. 347/93

(57) ABSTRACT

The invention relates to a liquid ejecting head that includes a liquid ejecting head body, a liquid-supply member, and a plurality of filters. The liquid-supply member has a plurality of liquid-supply passages formed inside the liquid-supply member used for communicating the liquid to the liquid ejecting head body. The liquid-supply member includes a first and second separate member which are adhered to each other so as to make up the liquid-supply member. A plurality of first and second filters are provided across the plurality of liquid-supply passages. The plurality of liquid-supply passages includes first liquid-supply passages that have the first filters on the surface of the first separate member and second liquid-supply passages that have the second filters on the surface of the second separate member.

The entire disclosure of Japanese Patent Application No. 2007-168807, filed Jun. 27, 2007 and Japanese Patent Application No. 2008-054156, filed Mar. 4, 2008 are expressly incorporated herein by reference.

### BACKGROUND OF THE INVENTION

1. Technical Field

The present invention generally relates to a liquid ejecting head capable of ejecting liquid from a plurality of nozzle openings formed in the surface of the liquid ejecting head. More specifically, the present invention relates to a liquid ejecting head comprising a liquid-retaining unit or container.

2. Related Art

Ink-jet recording heads are one example of variety of liquid ejecting heads that are widely used today. Typically, within the liquid ejecting heads, an ink-retaining unit or ink container supplies the ink to the ink ejection head body of the ink-jet recording head. For example, one non-limiting example of such an ink-containing unit is an ink cartridge. The recording heads operate by using a means for generating pressure such as a piezoelectric element or a heating element, though not limited thereto, which is capable of applying an ink-ejecting pressure force to the ink supplied from the ink-retaining unit to the ink-ejecting head body of the ink-jet recording head when driven. By repeating this process, the ink-jet recording head discharges ink drops from the nozzles to form a predetermined pattern.

Air bubbles are often present in the ink contained in the ink cartridge. These air bubbles often form when the ink cartridge is attached or detached, though air bubbles may be formed in a variety of ways. One difficulty with air bubbles in the ink cartridge is that the air bubbles may then be transferred to the ink supply from the ink cartridge to the ink ejection head body of the ink-jet recording head, where any entrapped air bubbles may adversely affect the print quality of the ink-jet recording head. For example, problems with the ink discharge may result in missing dots, or other noticeable errors. One solution to this problem includes ink-jet recording heads of the related art wherein filters are used to trap or catch any air bubbles or other foreign objects. Typically, these filters are provided between the ink-supply needles and cartridge case, such as in the example disclosed in Japanese Patent No. JP-A-11-10904 (see pages 2 and 3 of the specification and FIG. 1).

In the configuration disclosed in JP-A-11-10904, the filters are adhered to one surface of a cartridge case where the ink-supply needles are fixed or mounted. As such, the ink-jet recording head requires the ink-supply-needled-mounted surface of the cartridge case to have a large enough surface to house both the filters and the ink-supply needles. In addition, the ink-supply-needled-mounted surface needs enough space to form a margin or space between the ink-supply needles and filters. Because these space requirements, it is not possible to reduce the space between adjacent ink-supply needles.

As another disadvantage of ink-jet recording heads of the related art is that the dynamic pressure increases as the area of the filters is reduced so as to make the head smaller. Because of the increased dynamic pressure, it is necessary to increase the driving voltage applied to the pressure generating.

Another example of an ink-jet recording head of the related art that has air-trapping filters is found in Japanese Patent No. JP-A-2004-106214, which discloses a double-sided filter configuration wherein filters are provided on both surfaces of an ink-supply head member. In that configuration, the ink-supply head member supplies ink to a head body. One disadvantageous aspect of this configuration, however, is that some filters are adhered to one surface of the ink-supply head member after the other filters are adhered to the other surface of the ink-supply head member, causing a stress to be applied to the filters that are first adhered to the ink-supply head member. Applying this stress to the filters may damage the filters. For example, the filters may be deformed or even broken due to the stress. In addition, when some filters are adhered to one surface of the ink-supply head member before other filters are adhered to the other opposite surface of the ink-supply head member, the shapes of filter chambers may differ, depending on filter-adhesion positions. Such differences among the shapes and characteristics of the filter chambers may cause pressure losses and/or differences in air-trapping performance from one filter chamber to another.

### BRIEF SUMMARY OF THE INVENTION

An advantage of some aspects of the invention is a liquid ejecting head and liquid ejecting apparatus that are capable of increasing the area of each of filter and thus enhance the filtering characteristics and performance while reducing the size of the ink-supply head member.

One aspect of the present invention is a liquid ejecting head body including a plurality of nozzle openings, the liquid ejecting head body being capable of ejecting liquid that is supplied from a liquid container from the plurality of nozzle openings, a liquid-supply member disposed between the liquid container and the liquid ejecting body, comprised of a first and second separate member which are adhered together, the liquid-supply member having a plurality of liquid-supply passages formed inside the liquid-supply member which penetrate through the first and second separate members of the liquid-supply member, the plurality of liquid-supply passages being capable of transferring the liquid from the liquid container to each group of the plurality of nozzle openings of the liquid ejecting head, and a plurality of first and second filters provided across the plurality of liquid-supply passages, wherein the plurality of liquid-supply passages includes a plurality of first liquid-supply passages that have the first filters on the surface of the first separate member and a plurality of second liquid-supply passages that have the second filters on the surface of the second separate member.

A second aspect of the invention comprises a liquid ejecting head wherein a liquid ejecting head body that has a plurality of nozzle openings, the liquid ejecting head body being capable of ejecting liquid supplied from a liquid container from the plurality of nozzle openings, a liquid-supply member that has a plurality of liquid-supply passages formed inside the liquid-supply member, the plurality of liquid-supply passages being used for communicating the liquid to the liquid ejecting head body, and a plurality of first and second filters that are provided across the plurality of liquid-supply passages. The plurality of liquid-supply passages includes first liquid-supply passages which have the first filter provided across the first liquid-supply passage and the second liquid-supply passages have the second filter provided across the second liquid-supply passage, and the first filters provided across the first liquid-supply passages and the second filters provided across the second liquid-supply passages are arrayed in such a manner that the projected area of the first filters overlaps the projected are of the second filters as viewed from the filtering surface. The first liquid-supply passages has a first filter chamber including a widened portion of the first liquid-supply passage that is formed immediately upstream of the first filter and at the immediately downstream of the first filter, the second liquid-supply passages has a second filter chamber including a widened portion of the second liquid-supply passage that is formed immediately upstream of the second filter and immediately downstream of the second filter, and the first filter chamber of the first liquid-supply passages has substantially the same shape as that of the second filter chamber of the second liquid-supply passages.

If the configuration of a liquid ejecting head according to the aspects of the invention described above, it is possible to reduce the size of the liquid-supply member. In addition, it is possible to increase the area size of filters. As a result thereof, it is possible to decrease dynamic pressure. Since it is possible to decrease dynamic pressure, it is further possible to decrease a driving voltage that is applied to the means for generating pressure. Moreover, it is possible to make the lengths of the liquid-supply passages uniform, thereby preventing any variation or differences in the performance of the liquid-supply among the plurality of liquid-supply passages. Therefore, it is possible to achieve uniform liquid-discharging performance.

Furthermore, using the separate configuration of the liquid-supply member, which is made up of at least a first separate member and second separate member where the filters are adhered to the surface, it is possible to prevent the filters from being damaged, deformed, or even broken due to stress or pressure that is applied to the filters when the filters are adhered to the surface of the first separate member and second separate member. Moreover, it is possible to normalize the filtering characteristics, such as, pressure losses and/or air-trapping performance of these filter chambers substantially equal to one another regardless of the filtering positions across the liquid-supply passages.

### BRIEF DESCRIPTION OF THE DRAWINGS

The invention will be described with reference to the accompanying drawings, wherein like numbers reference like elements.

FIG. 1 is a perspective schematic view illustrating an ink-jet recording apparatus, which is an embodiment of a liquid ejecting apparatus of the present invention;

FIG. 2 is a perspective schematic view of an ink-jet recording head of the liquid ejecting heads shown in FIG. 1;

FIG. 3A is a sectional schematic view illustrating an example of the components of the ink-jet recording head of FIG. 1;

FIG. 3B is a top view of the components of the ink-jet recording head of FIG. 1;

FIG. 4A is a sectional view illustrating an example of the configuration of an ink-supply needle according to a first exemplary embodiment of the invention;

FIG. 4B is a sectional view illustrating an example of the configuration of another ink-supply needle according to the first exemplary embodiment of the invention;

FIG. 5A is a sectional view illustrating an example of the components of the ink-jet recording head of the related art;

FIG. 5B is a top view illustrating an example of the components of the ink-jet recording head of the related art;

FIG. 6 is a top view illustrating an example of an ink-supply head member of the ink-jet recording head according to a modified example of the first exemplary embodiment of the invention;

FIG. 7 is a top view illustrating an example of an ink-supply head member of the ink-jet recording head according to another modified example of the first exemplary embodiment of the invention;

FIG. 8 is a top view illustrating an example of an ink-supply head member of the ink-jet recording head according to still another modified example of the first exemplary embodiment of the invention; and

FIG. 9 is a top view illustrating an example of an ink-supply head member of the ink-jet recording head according to still another modified example of the first exemplary embodiment of the invention.

### DESCRIPTION OF EXEMPLARY EMBODIMENTS

With reference to the accompanying drawings, exemplary embodiments of the present invention are explained in detail below.

### Embodiment 1

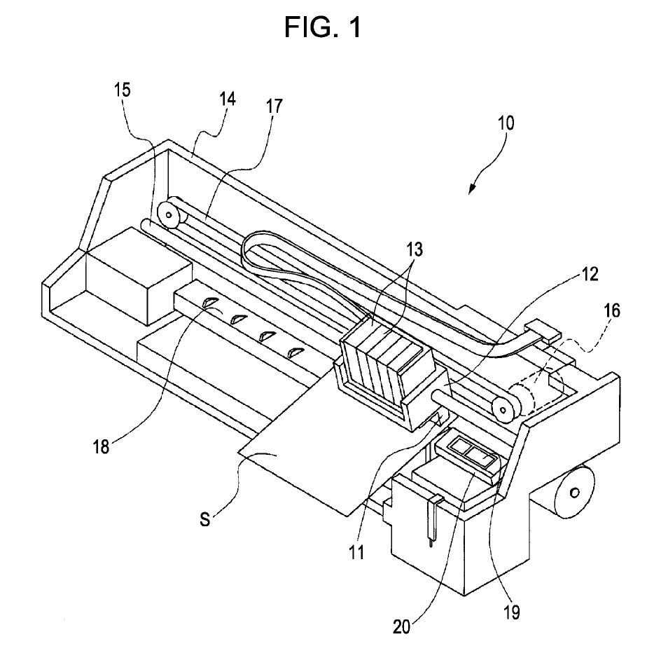

FIG. 1 is a perspective view that schematically illustrates an example of the configuration of an ink-jet recording apparatus, which is a non-limiting example of a liquid ejecting apparatuses according to a first exemplary embodiment of the invention. As illustrated in FIG. 1, the ink-jet recording apparatus 10 according to the present embodiment of the invention is provided with an ink-jet recording head 11 that is capable of discharging ink drops. The ink-jet recording head 11 is an example of a liquid ejecting head according to an aspect of the invention. The ink-jet recording apparatus 10 is further provided with a carriage 12. The ink-jet recording head 11 is fixed to the bottom of the carriage 12. Ink cartridges 13, each of which constitutes a non-limiting example of a liquid container capable of storing a liquid, are detachably attached to the ink-jet recording head 11. Each of these ink cartridges 13 contains ink which corresponds to one of a set of ink colors, for example, black (B), light black (LB), cyan (C), magenta (M), and yellow (Y), although the ink colors are not necessarily limited to this configuration. In the following description, the ink-jet recording head 11 is simply referred to as a “recording head” 11.

The carriage 12 is configured to move freely in the axial direction along a carriage axis 15, which is fixed to an apparatus body chassis 14. As the driving force of a driving motor 16 is communicated or transmitted to the carriage 12 by means of a plurality of gears (not shown) and a timing belt 17, the carriage 12 moves along the carriage axis 15. A platen 18 is provided in the apparatus body chassis 14 along the carriage axis 15. A recording target medium S such as a sheet of printing paper, though not limited thereto, is supplied to the apparatus 10 by a paper-feeding device (not shown) onto the platen 18.

A capping device 20 is provided at a position corresponding to the home position of the carriage 12, located at one end portion of the carriage axis 15. The capping device 20 is provided with a capping member 19 which seals the nozzle surface of the recording head 11. The capping device 20 prevents any ink remaining on the nozzle surface of the recording head 11, which has a number of nozzle holes/orifices formed therein, from drying, by sealing the nozzle surface of the recording head 11 with the capping member 19. The nozzle holes/orifices are non-limiting examples of the various nozzle openings that may be used in association with the invention. In addition to the nozzle-surface sealing function described above, the capping member 19 of the capping device 20 also functions as an ink catcher that is capable of capturing or receiving ink drops during a flushing operation.

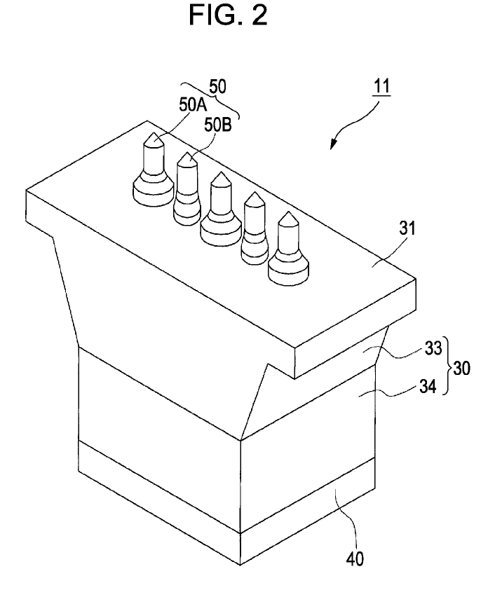

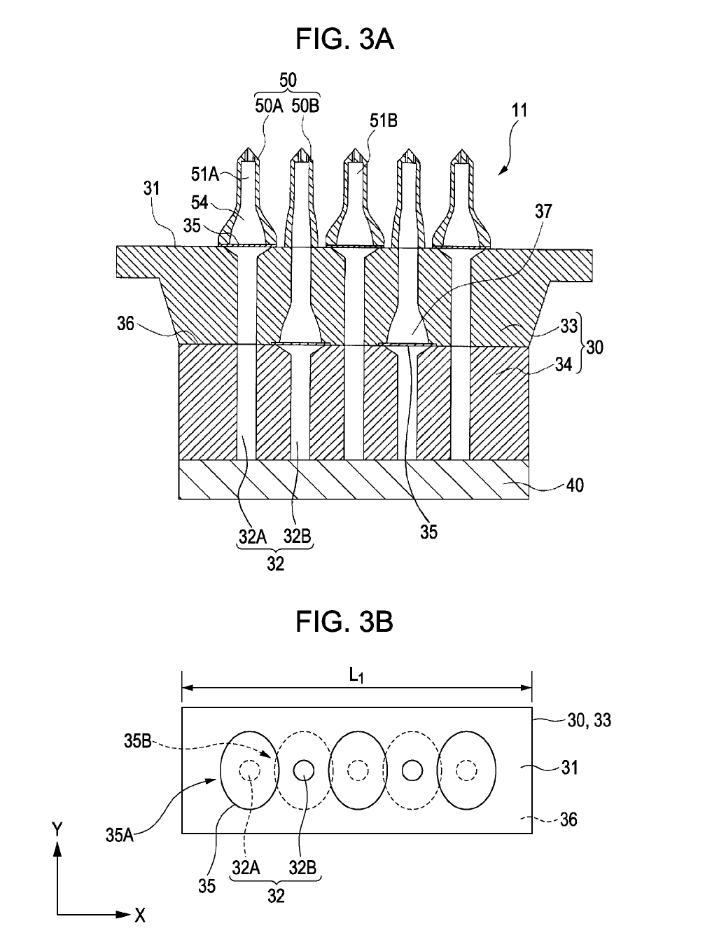

In the following description, the configuration of the recording head 11 according to one aspect of the invention will be described. FIG. 2 is a perspective view that schematically illustrates an exemplary configuration of an ink-jet recording head 11 of one embodiment of the invention. FIG. 3A is a sectional view that schematically illustrates the components of the ink-jet recording head according to the present embodiment of the invention. FIG. 3B is a top view that schematically illustrates an example of an ink-supply head member of the ink-jet recording head according to the present embodiment of the invention. In the following description, the ink-supply head member may be referred to as an ink-supplying head member or an ink-feed head member.

As illustrated in FIG. 2 and FIG. 3A, the recording head 11 has an ink-supply head member 30 and an ink-eject head body portion 40. An example of the ink-supply head member 30 is a cartridge case, though the present invention is not limited thereto. The aforementioned ink cartridges 13, which comprise a non-limiting example of a liquid container, are attached to the cartridge case acting as an ink-supply head member 30. The ink-eject head body portion 40 of the recording head 11 is fixed to one surface of the ink-supply head member 30 that is opposite to the surface of the ink-supply head member 30 where the ink cartridges 13 are attached.

The ink-supply head member 30 has a cartridge attachment portion 31 on the above-mentioned other surface thereof. Each of the ink cartridges 13, which herein act as non-limiting example of a liquid container as recited in the claims, are detachably attached to the cartridge attachment portion 31 of the ink-supply head member 30. A plurality of ink communicating passages 32 are provided in the ink-supply head member 30. The ink communicating passages 32 comprise non-limiting examples of the plurality of liquid-supply passages. Specifically, one end of each of the plurality of ink communicating passages 32 opens at the end of the cartridge-attachment-portion 31 of the ink-supply head member 30, whereas the other end thereof opens at the side facing the head-body-portion 40. Ink that is supplied from the ink cartridges 13 flows through the ink communicating passages 32 to reach the ink-eject head body portion 40 of the recording head 11. The plurality of ink communicating passages 32 are arranged adjacent to one another so as to form a line extending along the length of the ink-supply head member 30. Each of the ink-supply passages 32 is formed as an individual ink-communication channel that corresponds to a single ink cartridge 13 of a corresponding ink color.

The ink-supply head member 30 is made up of a plurality of separate components that are adhered to each other. For example, the ink-supply head member 30 may be made up of two component members 33 and 34 that are adhered to each other. One of these component members is on the side of the ink cartridge 13. The other component member is on the side of the head body 40. According to the present embodiment of the invention, the ink-supply head member 30 is made up of a first component member 33 and a second component member 34. The first component member 33 has the cartridge attachment portion 31. The ink-eject head body portion 40 is fixed to the second component member 34. Each ink-supply passage 32 formed in the ink-supply head member 30 penetrates through the first component member 33 and the second component member 34.

A filter 35 is provided for each of the plurality of ink-supply passages 32 of the ink-supply head member 30. The filter 35 traps air bubbles and/or foreign objects/particles that are trapped in liquid such as ink so as to remove them from the ink supply. Each of these filters 35 are provided across a corresponding ink-supply passage 32 of the ink-supply head member 30. That is, in the exemplary configuration described herein, each filter 35 is provided in such a manner that the filtering surface thereof extends in a direction that is orthogonal to the flowing direction of the ink inside the corresponding ink-supply passage 32 of the ink-supply head member 30. Notwithstanding this exemplary configuration, however, it is not necessary for the filtering surface of each of the filters 35 to be orthogonal to the direction of the ink flow and each of these filters 35 can offer expected filtering effects so long as the liquid is able to pass through the filter 35 as it flows through the corresponding ink-supply passage 32 of the ink-supply head member 30, regardless of whether the filter is perpendicular to the flowing direction or not.

Each of these filters 35 is provided either on the exposed surface of the ink-supply head member 30 or the non-exposed adhesion surface of the first component member 33 that is adhered to a surface of the second component member 34. Or, in other words, each of these filters 35 is provided either on the exposed surface of the ink-supply head member 30 or the non-exposed surface of the second component member 34 that is adhered to the surface of the first component member 33, since the adhesion surface of the adhesion of the first component member 33 and the second component member 34 can be considered a singled adhesion surface, herein referred to as an adhesion surface 36. It should be noted that the cartridge attachment portion 31 includes the portion of the surface of the ink-supply head member 30 that is exposed. It should particularly noted that the filters 35 are provided on the exposed surface (i.e., the cartridge attachment portion 31) of the ink-supply head member 30 and the non-exposed adhesion surface 36 such that at least one of the plurality of filters 35 is formed on each of these two different surfaces. That is, each filter 35 is provided on either the upstream surface of the first component member 33 or the upstream-side surface of the second component member 34 of the ink-supply passages 32 of the ink-supply head member 30. Or, in other words, some filters 35 are formed on the upstream surface of the first component member 33, whereas other filters 35 are formed on the upstream-side surface of the second component member 34. In the configuration of the recording head 11 according to the present embodiment of the invention, the ink-supply head member 30 is made up of three components, that is, the first component member 33, the second component member 34, and ink-supply needles 50. A more detailed explanation of the ink-supply needles 50 will be described below. The exposed portion of the surface of the ink-supply head member 30 comprising the cartridge attachment portion 31 of the ink-supply head member 30 described above, can also be defined as an ink-supply-needle-mount surface at wherein the first component member 33 and the ink-supply needles 50 are adhered to each other. The upper surface of the second component member 34 shown in FIG. 3A can be defined as the adhesion surface 36 between the first component member 33 and the second component member 34. Thus, some filters 35 are provided on the ink-supply-needle adhesion surface of the first component member 33 whereas other filters 35 are provided on the surface of the second component member 34 that is adhered to the first component member 33. In the foregoing description, the first and second component members 33 and 34 may comprise the first separate member and described in the claims below. However, since the ink-supply needles 50 illustrated in FIG. 3 constitute a component of the ink-supply head member 30 as explained above, it is possible to regard the ink-supply needles 50 as the first separate member claimed below and to further regard the first component member 33 illustrated in FIGS. 3A and 3B as the second separate member described in the claims below. If the ink-supply needles 50 shown in FIG. 3 are defined as the first separate member, the previous explanation can be paraphrased as follows: some filters 35 are provided on the downstream surface of the first separate member (i.e., the surface of the cartridge attachment portion 31). On the other hand, if the first component member 33 shown in FIG. 3 is defined as the second separate member, the ink-supply needles 50 shown in FIG. 3 are defined as the first separate member, the above explanation can be paraphrased as follows: some filters 35 are provided on the downstream surface of the second separate member (i.e., the adhesion surface 36). Or, as another alternative definition, it is possible to regard the second component member 34 illustrated in FIG. 3 as an example of a third separate member when the ink-supply needles 50 are defined as the first separate member described in the claims below.

Further, if the ink-supply needles 50 are defined as the first separate member, the first component member 33 is defined as the second separate member, and the second component member 34 shown in FIG. 3 is defined as the third separate member in the claims below, the above explanation can be further paraphrased as follows: some filters 35 are provided on the downstream surface of the first separate member (i.e., the cartridge attachment portion 31), whereas other filters 35 are provided on the upstream surface of the third separate member (i.e., the adhesion surface 36).

In the configuration of the recording head 11 according to the present embodiment of the invention, the plurality of ink-supply passages 32 of the ink-supply head member 30 are made up of two types of ink-supply passages, first ink-supply passages 32A and second ink-supply passages 32B. Each of the first ink-supply passages 32A has a corresponding filter 35 provided on either the exposed surface of the ink-supply head member 30 and the non-exposed adhesion surface 36 between the first component member 33 and the second component member 34. In the illustrated example, each of the first ink-supply passages 32A has a corresponding filter 35 provided on the exposed surface of the ink-supply head member 30. On the other hand, each of the second ink-supply passages 32B has a corresponding filter 35 provided on the opposite surface from where the filter 35 of each of the first ink-supply passages 32A are provided. In the illustrated example, since each of the first ink-supply passages 32A has a corresponding filter 35 provided on the exposed surface of the ink-supply head member 30, each of the second ink-supply passages 32B has a corresponding filter 35 provided on the non-exposed adhesion surface 36 between the first component member 33 and the second component member 34. That is, the plurality of first ink-supply passages 32A and the plurality of second ink-supply passages 32B make up the plurality of ink-supply passages 32 of the ink-supply head member 30.

More specifically, in this configuration, the filters 35 are provided on the cartridge attachment portion 31 of the ink-supply head member 30 in every other ink-supply passage 32. In addition, the filters 35 are also provided on the adhesion surface 36 between the first component member 33 and the second component member 34 in every other ink-supply passage 32 in such a manner that no filter 35 is provided on the adhesion surface 36 for an ink-supply passage 32 that also has a filter 35 on the cartridge attachment portion 31 of the ink-supply head member 30. Or, in other words, the filters 35 are provided on the adhesion surface 36 between the first component member 33 and the second component member 34 at other ink-supply passage 32 in such a manner that a filter 35 is provided on the adhesion surface 36 in each ink-supply passage 32 that has no filter 35 on the cartridge attachment portion 31 of the ink-supply head member 30. That is, the filters 35 are alternately provided in the ink-supply passages 32 on the cartridge attachment portion 31 of the ink-supply head member 30 and the adhesion surface 36 between the first component member 33 and the second component member 34 in such a manner that a line of the filters 35 is formed on the cartridge attachment portion 31 and another line of the filters 35 is formed on the adhesion surface 36 in order to form an alternate array pattern. Accordingly, in the configuration of the recording head 11 according to the present embodiment of the invention, there is no ink-supply passage 32 that has the filters 35 both on the cartridge attachment portion 31 of the ink-supply head member 30 and on the adhesion surface 36 between the first component member 33 and the second component member 34. In addition, there is no ink-supply passage 32 that does not have any filter 35 at all. In the illustrated example, and previously described, each of the first ink-supply passages 32A has a filter 35 on the exposed surface of the ink-supply head member 30, whereas each of the second ink-supply passages 32B a the filter 35 on the adhesion surface 36. The first ink-supply passages 32A and the second ink-supply passages 32B are alternately arrayed along the length of the ink-supply head member 30. In the following description, the direction of the alternate array of the first and second ink-supply passages 32A and 32B, respectively or length of the ink-supply head member 30, is referred to as a “X direction”.

In other words, as shown in FIG. 3B, the plurality of filters 35 form a line of filters 35A comprising a plurality of first-ink-supply-passage filters 35 arrayed on the cartridge attachment portion 31 of the ink-supply head member 30, and another line of filters 35B that is made up of a plurality of second-ink-supply-passage filters 35 arrayed on the adhesion surface 36 between the first component member 33 and the second component member 34.

As viewed from a direction perpendicular to the length of the ink-supply head member 30, which is hereafter denoted as the “Y direction” that is orthogonal to the above-defined X direction, the line of filters 35A and the line of filters 35B are along the same axis. Or, in other words, the line of filters 35A and the line of filters 35B are at the same position as viewed in the width (Y) direction of the ink-supply head member 30. Thus, the line of filters 35A and the line of filters 35B are in alignment with each other.

The plurality of filters 35 are provided in such a manner that no two adjacent filters in the X direction are formed on the same surface. That is, one filter 35 is provided on the cartridge-attachment-portion surface of the ink-supply head member 30, whereas each adjacent filter 35 is formed on the adhesion surface 36 between the first component member 33 and the second component member 34. This means that the first-ink-supply-passage filters 35 of the line of filters 35A that are provided on the cartridge attachment portion 31 of the ink-supply head member 30 and the second-ink-supply-passage filters 35 of the line of filters 35B that are provided on the adhesion surface 36 between the first component member 33 and the second component member 34 are shifted from each other along the length of the ink-supply head member 30, that is, along the above-defined X direction, by a shift amount equal to a half of the array pitch of the first-ink-supply-passage filters 35 (or the second-ink-supply-passage filters 35).

In addition, the first-ink-supply-passage filters 35 of the line of filters 35A that are provided on the cartridge attachment portion 31 of the ink-supply head member 30 and the second-ink-supply-passage filters 35 of the line of filters 35B that are provided on the adhesion surface 36 between the first component member 33 and the second component member 34 are provided in such a manner that two adjacent filters overlap each other as viewed in two dimensions along the filtering-surface direction. That is, the first-ink-supply-passage filters 35 of the line of filters 35A that are provided on the cartridge attachment portion 31 of the ink-supply head member 30, hereafter referred to as “first filters”, and the second-ink-supply-passage filters 35 of the line of filters 35B that are provided on the adhesion surface 36 between the first component member 33 and the second component member 34, hereafter referred to as “second filters”, overlap each other, at least slightly, in a plan view. Thus, the projected shape of the first filters and the projected shape/plane of the second filters as viewed from above the filtering surface thereof at least slightly overlap each other. The distance between two adjacent filters 35 provided on the cartridge-attachment-portion surface of the ink-supply head member 30 and the other adjacent filters 35 that is formed on the adhesion surface 36 between the first component member 33 and the second component member 34 is determined at the minimum possible value that is large enough so as to leave a needle-adhesion margin space, which is used for mounting the ink-supply needles 50 onto the ink-supply head member 30. A more detailed explanation thereof will be given later.

Each of the plurality of filters 35 may be made of metal that is woven into an ultra-fine mesh structure having a number of minute holes, though the material and/or structure of the filter 35 is not limited thereto.

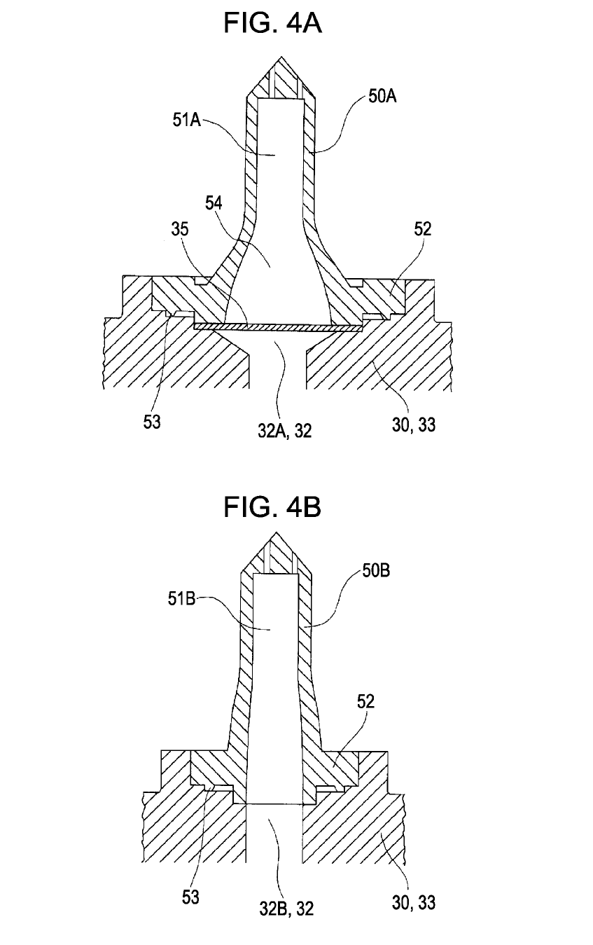

Each of the aforementioned ink-supply needles 50 is mounted at the open end of a corresponding ink-supply passage 32 on the cartridge attachment portion 31 of the ink-supply head member 30. In the following description, the structure of the ink-supply needles 50 is explained in detail while referring to FIGS. 4A and 4B. FIG. 4A is a sectional view that schematically illustrates the configuration of an ink-supply needle according to the first exemplary embodiment of the invention, whereas FIG. 4B is a sectional view that schematically illustrates an example of the configuration of another ink-supply needle according to the first exemplary embodiment of the invention.

The ink-supply needles 50 are made up of first ink-supply needles 50A and second ink-supply needles 50B. As illustrated in FIG. 3A, the first ink-supply needles 50A are provided for the first ink-supply passages 32A, each of which has the first filter 35 on the exposed surface of the ink-supply head member 30. The second ink-supply needles 50B are, as shown therein, provided for the second ink-supply passages 32B, each of which has the second filter 35 on the adhesion surface 36 between the first component member 33 and the second component member 34. It should be noted that the second ink-supply needles 50B are provided for the second ink-supply passages 32B, meaning that the second ink-supply passages 32B do not have the first filter 35 on the exposed surface of the ink-supply head member 30 and thus directly open at the above-mentioned surface.

As illustrated in FIG. 4A, each of the first ink-supply needles 50A has a first inner-needle through-hole passage 51A that is in communication with a corresponding first ink-supply passage 32A formed inside the ink-supply head member 30. Each of the first ink-supply needles 50A further has a flange portion 52 near the ink-supply-head-member-side end. It should be noted that only one first ink-supply needle 50A is illustrated in FIG. 4A. A combination of the first inner-needle through-hole passage 51A of each of the first ink-supply needles 50A and the corresponding one of the first ink-supply passages 32A formed inside the ink-supply head member 30 constitutes an ink-flow channel through which ink is supplied from the ink cartridge 13 to the ink-eject head body portion 40.

A fusion-bond projection 53 is formed on the flange portion 52 of each of the first ink-supply needles 50A. The fusion-bond projection 53 is formed on a surface of the flange portion 52 of the first ink-supply needle 50A that will become, after fusion thereof, a needle adhesion surface between the first ink-supply needle 50A and the ink-supply head member 30. The fusion-bond projection 53 that is formed on the flange portion 52 of each of the first ink-supply needles 50A is melted and welded to the ink-supply head member 30 by means of an ultrasonic fusion-bonding technique. As a result thereof, the first filter 35 is disposed between the first ink-supply needle 50A and the ink-supply head member 30.

A first filter chamber 54 is formed as a part of the above-mentioned ink-flow channel at the connection region of the first inner-needle through-hole passage 51A of each of the first ink-supply needles 50A near the corresponding first ink-supply passage 32A formed inside the ink-supply head member 30. The inner diameter of the first filter chamber 54 is larger than that of other region of the first inner-needle through-hole passage 51A. That is, the first filter chamber 54 is formed as a widened portion of the ink-flow channel. In the configuration of the first ink-supply needle 50A of the present embodiment of the invention, the first filter chamber 54 has an upside-down funnel structure. Therefore, the inner diameter of the first filter chamber 54 on the ink-cartridge 13 side is relatively small. Or, in other words, the inner diameter of the first filter chamber 54 increases toward the first-filter 35. The reason why the first filter chamber 54 has a larger inner diameter than the other regions of the first inner-needle through-hole passage 51A is that such a structure increases the effective area of the first filter 35 so as to minimize the resistance that occurs when ink passes through the first filter 35.

On the other hand, as illustrated in FIG. 4B, each of the second ink-supply needles 50B has a second inner-needle through-hole passage 51B that is in communication with a corresponding second ink-supply passage 32B formed inside the ink-supply head member 30. Each of the second ink-supply needles 50B further has a flange portion 52 near the ink-supply-head-member end. It should be noted that only one second ink-supply needle 50B only is illustrated in FIG. 4B.

The second inner-needle through-hole passage 51B of the second ink-supply needle 50B has substantially the same diameter as that of the second ink-supply passage 32B formed inside the ink-supply head member 30. In contrast, however, the second ink-supply needles 50B do not have the first filter chamber 54.

As in the configuration of the first ink-supply needle 50A according to the present embodiment of the invention described above, a fusion-bond projection 53 is formed on the flange portion 52 of each of the second ink-supply needles 50B. The fusion-bond projection 53 is formed on a surface of the flange portion 52 of the second ink-supply needle 50B that will become, after fusion thereof, a needle adhesion surface between the second ink-supply needle 50B and the ink-supply head member 30. The fusion-bond projection 53 that is formed on the flange portion 52 of each of the second ink-supply needles 50B is melted and welded to the ink-supply head member 30 by a fusion-bonding method.

Each of the second ink-supply passages 32B that have the second filter 35 on the adhesion surface 36A between the first component member 33 and the second component member 34 has a second filter chamber 37, shown in FIG. 3A, which is formed as a part of the above-mentioned ink-flow channel. As illustrated in FIG. 3A, the inner diameter of the second filter chamber 37 is larger than that of other region of the ink-flow channel. That is, the second filter chamber 37 also comprises a widened portion of the ink-flow channel. In the configuration of the second ink-supply passage 32B according to the present embodiment of the invention, the second filter chamber 37 has also an upside-down funnel structure. Therefore, the inner diameter of the second filter chamber 37 at the ink-cartridge 13 side of the second filter chamber 27 is relatively small. Or, in other words, the inner diameter of the second filter chamber 37 increases toward the second-filter 35. In the configuration of the recording head 11 according to the present embodiment of the invention, each of the plurality of ink-supply passages 32 has an individual downstream-side filter chamber, that is, a downstream-side filtering compartment or a downstream-side filtering space. As its name indicates, the downstream-side filter chamber of each of the plurality of ink-supply passages 32 is formed immediately downstream to the corresponding filters 35. The downstream-side filter chamber of each of the plurality of ink-supply passages 32 is formed to have a normal funnel structure. Therefore, the inner diameter of each of the downstream-side filter chambers towards the filter 35 is relatively large. The reason why each of the plurality of ink-supply passages 32 has the individual downstream-side filter chamber is to increase the effective area of the filter 35. That is, if the region of the ink-supply passage 32 immediately downstream to the filter 35 has an inner diameter that is much smaller than that of the filter 35, a large part of the filtering area of the filter 35 is wasted because it does not actually contribute to the trapping of air bubbles and/or foreign objects or particles that are trapped in the liquid. This substantially reduces the effective area of the filter 35 to the narrowed open area of the downstream region of the ink-supply passage 32, which has a smaller inner diameter than that of the filter 35. It should be noted that the first filter chamber 54 that is formed on the upstream-side filter chamber of each of the first ink-supply passages 32A has substantially the same shape as that of the second filter chamber 37 that is formed as the upstream-side filter chamber of each of the second ink-supply passages 32B. It should be further noted that the downstream-side filter chamber of each of the first ink-supply passages 32A has substantially the same shape as that of the downstream-side filter chamber of each of the second ink-supply passages 32B. That is, both of the upstream-side filter chamber and the downstream-side filter chamber of each of the first ink-supply passages 32A have substantially the same shapes as those of the upstream-side filter chamber and the downstream-side filter chamber of each of the second ink-supply passages 32B, respectively. The shapes of the upstream-side filter chambers are uniform among the plurality of ink-supply passages 32. The shapes of the downstream-side filter chambers are also uniform among the plurality of ink-supply passages 32. The funneling orientation and shape of the upstream-side filter chamber of each of the first ink-supply passages 32A is the same as that of the upstream-side filter chamber of each of the second ink-supply passages 32B. In addition, the funneling orientation and shape of the downstream-side filter chamber of each of the first ink-supply passages 32A is the same as that of the downstream-side filter chamber of each of the second ink-supply passages 32B. Thus, there is not any single ink-supply passage 32 that has a reverse chamber structure.

As explained above, in the configuration of the recording head 11 according to the present embodiment of the invention, each of the first ink-supply needles 50A has the first filter chamber 54, whereas none of the second ink-supply needles 50B has any filter chamber. For this reason, it is possible to make the outer diameter of each of the second ink-supply needles 50B smaller than that of each of the first ink-supply needles 50A. Such a configuration is advantageous in that it is possible to array the first ink-supply needles 50A and the second ink-supply needles 50B in close proximity to each other.

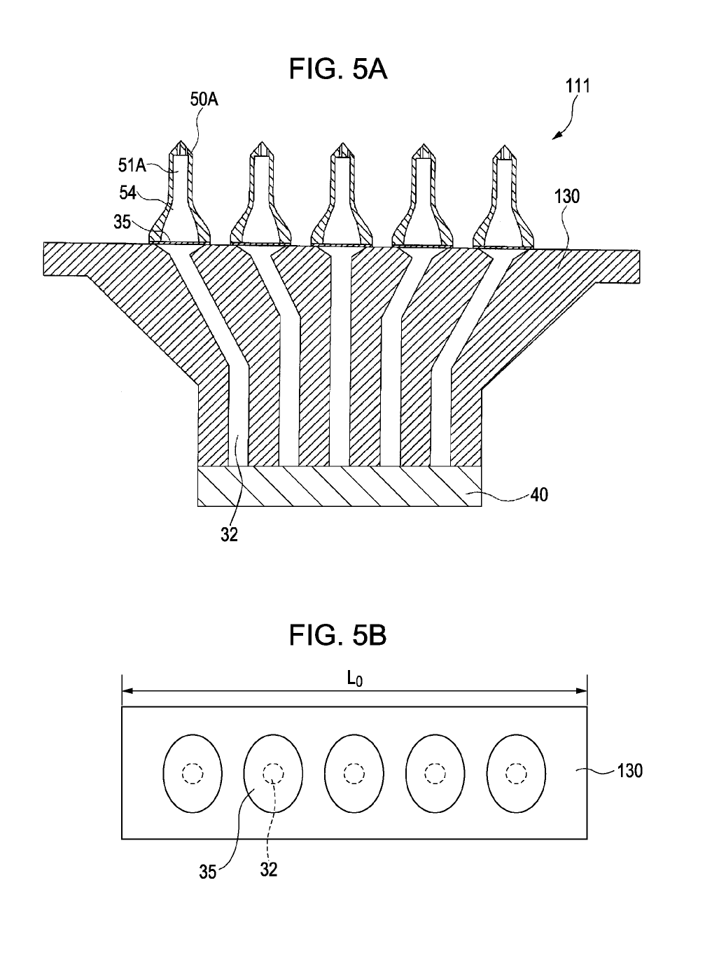

As further explained above, in the configuration of the ink-supply head member 30 according to the present embodiment of the inventions the filters 35 are provided on two different surfaces, that is, the cartridge-attachment-portion surface of the ink-supply head member 30 and the adhesion surface 36 between the first component member 33 and the second component member 34. Therefore, it is possible to make the size of the recording head 11 smaller. Specifically, if the filters 35 were arrayed only on one surface, such as the exposed surface (i.e., cartridge-attachment-portion-side surface) of an ink-supply head member 130, such as in the configuration shown in FIG. 5, the length L₀ of the ink-supply head member 130 is would be relatively large, which is not desirable. In contrast, in the configuration of the ink-supply head member 30 according to the present embodiment of the invention, the filters 35 are provided on two different surfaces, the cartridge-attachment-portion surface of the ink-supply head member 30 and the adhesion surface 36 between the first component member 33 and the second component member 34 as shown in FIG. 3. Using this configuration, it is possible to narrow the distance between one of each two adjacent filters 35, since one is provided on the cartridge-attachment-portion surface of the ink-supply head member 30 and the two adjacent filters 35 are formed on the adhesion surface 36 between the first component member 33 and the second component member 34. In comparison with the filter-array configuration of the ink-supply head member 130 of the related art, the filter-array configuration of the ink-supply head member 30 according to the present embodiment of the invention has a smaller length L₁ because it is possible to narrow the distance between adjacent filters 35. If the plurality of ink-supply passages 32 is formed inside the ink-supply head member 30 in such a manner that the distance between one of each two adjacent filters 35 and the other thereof minimized so as to leave a sufficient needle-adhesion margin space, which is used for mounting the first ink-supply needles 50A and the second ink-supply needles 50B onto the cartridge attachment portion 31 of the ink-supply head member 30, while achieving the smallest length L₁ of the ink-supply head member 30. In the foregoing sentence, it should be noted that configuration currently known in the art, the distance between adjacent filters 35 is measured on the cartridge-attachment-portion surface of the ink-supply head member 30, whereas in the embodiment of the present invention the distance between two adjacent filters 35 is measured as the distance between a filter 35 formed on the cartridge-attachment-portion surface and the filter 35 formed on the adhesion surface 36 between the first component member 33 and the second component member 34. The outer diameter of each of the first ink-supply needles 50A is determined based on the inner diameter of each of the ink-supply passages 32 and the area of each of the filters 35. The outer diameter of each of the second ink-supply needles 50B is also determined based on the inner diameter of each of the ink-supply passages 32 and the area of each of the filters 35.

In the configuration of the ink-supply head member 30 according to the present embodiment of the invention, it is possible to narrow the distance between adjacent filters 35 provided on the cartridge-attachment-portion surface of the ink-supply head member 30 and the adhesion surface 36 between the first component member 33 and the second component member 34 because the filters 35 are provided on the above-described two surfaces that are different from each other. For this reason, it is possible to enlarge the area size of each of the filters 35. As a result thereof, it is possible to decrease dynamic pressure required to filter the ink. Since it is possible to decrease dynamic pressure, it is further possible to decrease a driving voltage that is applied to a means for generating pressure provided in the ink-eject head body portion 40. Additionally, it is possible to reduce the size of the ink-supply head member 30 smaller.

Since the size of the ink-supply head member 30 can be made smaller, it is not necessary to form bent (or curved) ink-flow channels unlike the ink-supply head member 130 of the related art shown in FIG. 5. Thus, the ink-flow-channels may be straight, making it possible to make the lengths of the ink-supply passages 32 that supply ink from the ink cartridges 13 to the ink-eject head body portion 40 the same or substantially the same length. Since the lengths of the ink-supply passages 32 are substantially the same length, it is possible to prevent differences in ink-supply performance, such as flow-channel resistance, amongst the one ink-supply passages 32. By this means, it is possible to normalize the discharging characteristics of the nozzle openings of the ink-eject head body portion 40.

In addition, since it is possible to reduce the size of the ink-supply head member 30, it is also possible to reduce the size of the ink-eject head body portion 40, which is fixed to the ink-supply head member 30. Therefore, it is possible to reduce the size of the recording head 11.

The magnitude of a separate-member adhesion force that is required/applied at the time when the first component member 33 and the second component member 34 are adhered to each other is smaller than that of a filter adhesion force that is required/applied at the time when the filters 35 are adhered to the surface of each of the first component member 33 and the second component member 34. For this reason, the separate configuration of the ink-supply head member 30, which is made up of the first component member 33 and the second component member 34, as well as the separate adhesion of the filters 35 to the surface of each of the first component member 33 and the second component member 34 prevents the filters 35 from being damaged, deformed, or broken due to the stress or pressure applied to the filters 35 when the filters 35 are adhered to the surface of each of the first component member 33 and the second component member 34.

For example, as previously described, in the configuration currently known in the art, where some filters 35 are adhered to one surface of the ink-supply head member after the adhesion of other filters 35 to the opposite surface of the ink-supply head member, a stress is applied to the above-mentioned other filters 35 that have already been adhered to the opposite surface of the ink-supply head member. This stress may damage the filters 35. More specifically, the filters 35 may be deformed or even broken due to the stress applied thereto when the subsequent set of filters 35 are adhered to the second surface of the ink-supply head member.

In contrast, in the recording head 11 according to the present embodiment of the invention, the first component member 33 and the second component member 34 are adhered to each other with an adhesion force that is smaller in strength or magnitude than the adhesion force that is applied when the filters 35 are adhered to the surface of each of the first component member 33 and the second component member 34. In addition, in the production of the recording head 11 according to the present embodiment of the invention, the first component member 33 and the second component member 34 are adhered to each other only after the filters 35 have already been adhered to the surface of each of the first component member 33 and the second component member 34. By this means, it is possible to avoid any excessive force from being applied to the filters 35.

In the configuration of the recording head 11 according to the present embodiment of the invention, the first filter chamber 54 that is formed upstream to the first ink-supply passages 32A has substantially the same shape as that of the second filter chamber 37 that is formed upstream to of each of the second ink-supply passages 32B. In addition, in the configuration of the recording head 11 according to the present embodiment of the invention, the filter chamber formed downstream of each of the first ink-supply passages 32A has substantially the same shape as the filter chamber formed downstream to each of the second ink-supply passages 32B. With such a structure, it is possible to normalize the filtering characteristics of the filtering chambers, including pressure loss and/or air-trapping performance, regardless of the adhesion positions of the filters 35 in the ink-supply passages 32. By this means, it is possible to normalize or make uniform the ink-supply performance of the ink-supply passages 32 and thus further equalize the discharging characteristics of the ink from the nozzle openings of the ink-eject head body portion 40.

The ink-eject head body portion 40 of the recording head 11 has nozzle lines provided in parallel with one another (or each other). Each of these nozzle lines is made up of a number of nozzle openings (not shown). The ink-eject head body portion 40 discharges ink of respective colors from these nozzle lines. That is, each of the plurality of ink-supply passages 32 of the ink-supply head member 30 is provided to a corresponding nozzle line of the ink-eject head body portion 40.

Any related-art ink-eject head body portion may be adopted as the ink-eject head body portion 40 of the recording head 11 so long as it is capable of discharging ink or fluid from the nozzle openings thereof that has been supplied from the ink cartridges 13 or other liquid container to the ink-eject head body portion 40 of the recording head 11 through the ink-supply head member 30. For example, the ink-eject head body portion 40 of the recording head 11 may be configured as a liquid ejecting head that has pressure generation chambers and a means for generating pressure. The pressure generation chamber is formed on a liquid flow channel that is in communication with the ink-supply passage 32 of the ink-supply head member 30 at one end the nozzle opening at the other end. The means for generating pressure causes a pressure change in the pressure generation chamber. The means for generating pressure can be embodied as a variety of actuator devices or other kind of devices. A non-limiting example of one means for generating pressure that may be used in association with the present invention is a longitudinal-vibration actuator device. The longitudinal-vibration actuator device may comprise laminating alternating layers of piezoelectric material and an electrode formation material. Such a piezoelectric-electrode laminated actuator device can expand and contract in an axial direction. Another non-limiting example a means for generating pressure that may be used in association with the present invention is a deflecting-vibration-type actuator device. For example, a thin-film-type actuator device may be used, which is formed by laminating an electrode formation material and a piezoelectric material by means of a film deposition method and a lithography method. Alternatively, a thick-film-type actuator device may be used, which is formed by adhering a plurality of green sheet(s) to a piezoelectric material.

As still another non-limiting example, the means for generating pressure may comprise a thermal-discharging actuator device. In such a modified configuration, a heating element/device may generate heat in the pressure generation chamber. The thermal-discharging actuator device discharges drops of liquid (e.g., ink drops) from the nozzles by utilizing bubbles formed as a result of heat generation.

In still another non-limiting example, the means for generating pressure may comprise a so-called electrostatic actuator device. In such a modified configuration, static electricity is generated between a vibrating plate and electrodes, which is used to deflect the vibrating plate in order to discharge liquid drops from the nozzles.

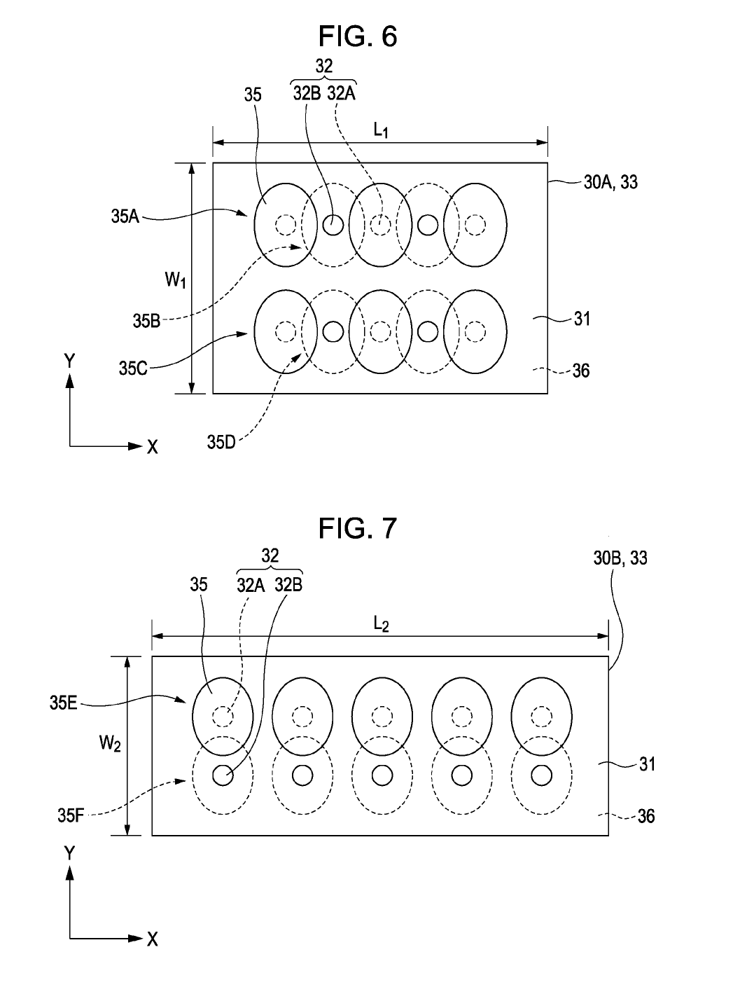

In addition, the unique array of the filters 35 is not limited to the specific example described above. In the following description, examples of modified filter array patterns which differ from the example described above are explained while making reference to FIGS. 6-9. Each of FIGS. 6, 7, 8, and 9 is a top view that schematically illustrates an example of an ink-supply head member of the ink-jet recording head that may be used according to an additional embodiment of the invention.

As illustrated in FIG. 6, an ink-supply head member 30A has a dual ink-supply-passage line structure. Specifically, the plurality of ink-supply passages 32 are arrayed adjacent to one another so as to form not a single line but a pair of lines each of which extends along the length of the ink-supply head member 30A, that is, along the X direction. The two ink-supply-passage lines are parallel to each other. Accordingly, one of these two ink-supply-passage lines is at a certain position along the width of the ink-supply head member 30A, whereas the other ink-supply-passage line is at another position, meaning that the two ink-supply-passage lines are separated by a predetermined distance in the Y direction. Each of these two ink-supply-passage lines that extend along the length of the ink-supply head member 30A have first-ink-supply-passage filters 35 that were previously described as being provided on the cartridge attachment portion 31 of the ink-supply head member 30A and the second-ink-supply-passage filters 35 have the second-ink-supply-passage line of filters that were previously described as being provided on the adhesion surface 36 between the first component member 33 and the second component member 34. In this respect, the configuration of the ink-supply head member 30A described herein is similar to that of the ink-supply head member 30 according to the first exemplary embodiment of the invention although the ink-supply head member 30A described in this embodiment has a dual ink-supply-passage line structure.

More specifically, in the configuration of the ink-supply head member 30A described in this embodiment, two first-ink-supply-passage line of filters 35A and 35C are provided on the cartridge attachment portion 31 of the ink-supply head member 30A. In addition, the two second-ink-supply-passage line of filters 35B and 35D are provided on the adhesion surface 36 between the first component member 33 and the second component member 34.

The first-ink-supply-passage filters 35 of the first-ink-supply-passage line of filters 35A that are provided on the cartridge attachment portion 31 of the ink-supply head member 30A and the second-ink-supply-passage filters 35 of the second-ink-supply-passage line of filters 35B that are provided on the adhesion surface 36 between the first component member 33 and the second component member 34 form an alternate array pattern. Each of these filters 35 are provided so as to correspond with the ink-supply passages 32. Similarly, the first-ink-supply-passage filters 35 of the first-ink-supply-passage line of filters 35C that are provided on the cartridge attachment portion 31 of the ink-supply head member 30A and the second-ink-supply-passage filters 35 of the second-ink-supply-passage line of filters 35D that are provided on the adhesion surface 36 between the first component member 33 and the second component member 34 form an alternate array pattern. Each of these filters 35 corresponds with an ink-supply passage 32. Accordingly, the first-ink-supply-passage line of filters 35A and 35C are provided on the cartridge attachment portion 31 of the ink-supply head member 30A, whereas the second-ink-supply-passage line of filters 35B and 35D are provided on the adhesion surface 36 between the first component member 33 and the second component member 34. The first-ink-supply-passage filters 35 of the first-ink-supply-passage line of filters 35A and 35C are provided on the cartridge attachment portion 31 of the ink-supply head member 30 on every other ink-supply passage 32. On the other hand, the second-ink-supply-passage filters 35 of the second-ink-supply-passage line of filters 35B and 35D are provided on the adhesion surface 36 between the first component member 33 and the second component member 34 on every other ink-supply passage 32. It is herein assumed for the purpose of explanation that, without any intention to limit the scope of the modified filter array described herein, each of the first ink-supply passages 32A has the first-ink-supply-passage filter 35 on the exposed surface of the ink-supply head member 30A while each of the second ink-supply passages 32B has the second-ink-supply-passage filter 35 on the adhesion surface 36 between the first component member 33 and the second component member 34. The first ink-supply passages 32A and the second ink-supply passages 32B are arrayed in an alternating order as viewed in the length of the ink-supply head member 30A, or X direction. In the configuration of the ink-supply head member 30A described herein, the alternate array pattern of the first ink-supply passages 32A and the second ink-supply passages 32B comprise the above-mentioned dual ink-supply-passage lines that are parallel to each other. Accordingly, one of these two ink-supply-passage lines is at a certain position in the Y direction, whereas the other ink-supply-passage line is at another position in the Y direction.

In other words, the lines of filters 35A and 35C are each formed on the cartridge attachment portion 31 of the ink-supply head member 30A at the same position in the X direction. The line of filters 35A and the line of filters 35C are formed in parallel to each other as viewed in the width direction of the ink-supply head member 30A. On the other hand, the line of filters 35B and the line of filters 35D each of which is formed on the adhesion surface 36 between the first component member 33 and the second component member 34 of the ink-supply head member 30A are formed at the same X position of the ink-supply head member 30A. The line of filters 35B and the line of filters 35D are formed in parallel to each other as viewed in the width direction of the ink-supply head member 30A.

If the modified filter array pattern explained above is adopted, it is possible to make the length L₁ of the ink-supply head member 30A smaller in comparison with that of a non-separated configuration in which all filters 35 are arrayed on the exposed surface of an ink-supply head member in a dual line arrangement. Therefore, the modified filter array pattern explained above makes it possible to reduce the size of the recording head 11. Although the width W₁ of the ink-supply head member 30A is the same as that of the non-separated ink-supply head member whose filters 35 are arrayed on the exposed surface in a conventional dual line arrangement, the modified filter array pattern explained above is advantageous in that it is possible to make the length L₁ of the ink-supply head member 30A smaller.

FIG. 7 illustrates another example of a modified filter array that may be used in association with the present invention. As shown in FIG. 7, the first-ink-supply-passage filters 35 provided on the cartridge attachment portion 31 of an ink-supply head member 30B are formed on the exposed surface thereof. The first-ink-supply-passage filters 35 are arrayed adjacent to one another so as to form a single line that extends along the length direction of the ink-supply head member 30B or along the X direction. This line of filters 35 is denoted as 35E. In addition, the second-ink-supply-passage filters 35 are provided on the adhesion surface 36 between the first component member 33 and the second component member 34 of the ink-supply head member 30B. The second-ink-supply-passage filters 35 are arrayed adjacent to one another so as to form another single line that extends along the length of the ink-supply head member 30B, or along the X direction. This line of filters 35 is denoted as 35F. The position of the second-ink-supply-passage line of filters 35F is shifted from the position of the first-ink-supply-passage line of filters 35E a predetermined distance in the Y direction that is orthogonal to the X direction. That is, the position of the second-ink-supply-passage line of filters 35F is shifted from the position of the first-ink-supply-passage line of filters 35E along the width of the ink-supply head member 30B. Therefore, the first-ink-supply-passage line of filters 35E that is formed on the cartridge attachment portion 31 of an ink-supply head member 30B and the second-ink-supply-passage line of filters 35F that is formed on the adhesion surface 36 are not in alignment with each other as viewed from the length direction of the ink-supply head member 30B. That is, the first-ink-supply-passage line of filters 35E and the second-ink-supply-passage line of filters 35F are at different positions from each other in the Y direction.

It is herein assumed, without any intention to limit the scope of the modified filter array example described herein, that each of the first ink-supply passages 32A has the first-ink-supply-passage filter 35 on the exposed surface of the ink-supply head member 30B whereas each of the second ink-supply passages 32B has the second-ink-supply-passage filter 35 on the adhesion surface 36 between the first component member 33 and the second component member 34. Based on this assumption, the first ink-supply passages 32A each of which has the first-ink-supply-passage filter 35 on the exposed surface of the ink-supply head member 30B are arrayed so as to form a single line that extends in the X direction. In addition, the second ink-supply passages 32B which have the second-ink-supply-passage filter 35 on the adhesion surface 36 are arrayed so as to form another single line that extends in the X direction. The line of the first ink-supply passages 32A is in parallel to the line of the second ink-supply passages 32B. Accordingly, the first ink-supply passages 32A and the second ink-supply passages 32B are adjacent to each other as viewed in the Y direction which is orthogonal to the X direction.

If the modified filter array pattern explained above is adopted, it is possible to make the width W₂ of the ink-supply head member 30B smaller in comparison with that of a non-separated configuration in which all filters 35 are arrayed on the exposed surface of an ink-supply head member as dual lines. Therefore, the modified filter array pattern explained above makes it possible to reduce the size of the recording head 11. Although the length L₂ of the ink-supply head member 30B is the same as that of the non-separated ink-supply head member whose filters 35 are arrayed on the exposed surface, the modified filter array pattern explained above is advantageous in that it is possible to make the width W₂ of the ink-supply head member 30B smaller.

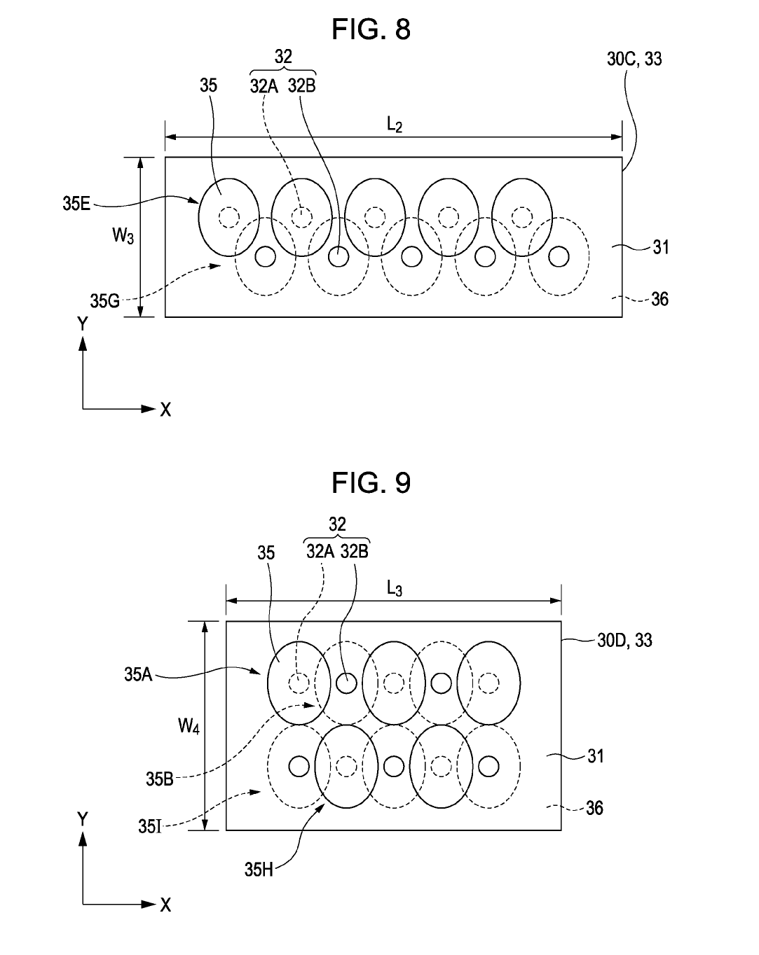

FIG. 8 illustrates still another modified filter array example is explained. As shown in FIG. 8, the first-ink-supply-passage line of filters 35E, which forms a single line, is formed on the cartridge attachment portion 31 of an ink-supply head member 30C, that is, on the exposed surface of the ink-supply head member 30C. In addition, the second-ink-supply-passage filters 35 are provided on the adhesion surface 36 between the first component member 33 and the second component member 34 of the ink-supply head member 30C. The second-ink-supply-passage filters 35 are arrayed adjacent to one another so as to form another single line that extends along the length of the ink-supply head member 30C, that is, along the X direction. In the illustrated example, the single line of the second-ink-supply-passage filters 35 is denoted as 35G. The position of the second-ink-supply-passage line of filters 35G is shifted from the position of the first-ink-supply-passage line of filters 35E a predetermined distance in the Y direction. That is, the position of the second-ink-supply-passage line of filters 35G is shifted from the position of the first-ink-supply-passage line of filters 35E a distance along the width of the ink-supply head member 30C. In addition, the position of the second-ink-supply-passage line of filters 35G is shifted from the position of the first-ink-supply-passage line of filters 35E as viewed in the X direction by a shift amount equal to a half of the array pitch of the first-ink-supply-passage filters 35. Accordingly, these first-ink-supply-passage filters 35 and second-ink-supply-passage filters 35 that are provided on two different surfaces and may be arranged into staggered or zigzag filter array patterns.

In other words, in the configuration of the ink-supply head member 30C, the line of the first ink-supply passages 32A is parallel to the line of the second ink-supply passages 32B but is shifted from the position of the second ink-supply passages 32B a predetermined distance Y direction by a shift amount equal to a half of the filter array pitch.

If the modified filter array pattern explained above is adopted, it is possible to further decrease the gap between the first-ink-supply-passage filters 35 of the first-ink-supply-passage line of filters 35E that are provided on the cartridge attachment portion 31 of the ink supply head member 30 and the second-ink-supply-passage filters 35 of the second-ink-supply-passage line of filters 35G that are provided on the adhesion surface 36 between the first component member 33 and the second component member 34. Therefore, it is possible to make the width W₃ of the ink-supply head member 30C smaller in comparison with the width W₂ of the ink-supply head member 30B shown in FIG. 7.

Still another example of a filter array is shown in FIG. 9. In FIG. 9, the ink-supply head member 30D has a dual alternate filter array pattern that is made up of a normal alternate line and a reverse alternate line. More specifically, one of the two alternate line of filters has the same filter array pattern as that of the ink-supply head member 30 according to the foregoing first exemplary embodiment of the invention, shown in FIG. 3B. On the other hand, the other line of filters has a reverse filter array pattern, which is opposite to the filter array pattern of the ink-supply head member 30 shown in FIG. 3B. Thus, in this embodiment, each of the first ink-supply passages 32A has a first-ink-supply-passage filter 35 on the cartridge attachment portion 31 of the ink-supply head member 30D, whereas each of the second ink-supply passages 32B has the second-ink-supply-passage filter 35 on the adhesion surface 36 between the first component member 33 and the second component member 34. Thus, the first ink-supply passages 32A and the second ink-supply passages 32B are arrayed in an alternating order as viewed along the length of the ink-supply head member 30D.

In the configuration of the ink-supply head member 30D described herein, two first-ink-supply-passage line of filters 35A and 35H are provided on the cartridge attachment portion 31. In addition, the position of the first-ink-supply-passage line of filters 35H is shifted from the position of the first-ink-supply-passage line of filters 35A in the Y direction, by a shift amount equal to a half of the array pitch of the first-ink-supply-passage filters 35. On the other hand, in the configuration of the ink-supply head member 30D described herein, two second-ink-supply-passage line of filters 35B and 35I are provided on the adhesion surface 36 between the first component member 33 and the second component member 34. In addition, the position of the second-ink-supply-passage line of filters 35I is shifted from the position of the second-ink-supply-passage line of filters 35B in the Y direction, by a shift amount equal to a half of the array pitch of the second-ink-supply-passage filters 35. The shift pattern of the second-ink-supply-passage line of filters 35B and 35I is reversed so as to be the opposite of the first-ink-supply-passage line of filters 35A and 35H. If the modified filter array pattern explained above is adopted, it is possible to make both of the length L₃ of the ink-supply head member 30D and the width W₄ thereof smaller than those of the ink-supply head members 30A, 30B, and 30C explained above, which are shown in FIGS. 6, 7, and 8, respectively. The length L₃ of the ink-supply head member 30D is equal to the length L₁ of the ink-supply head member 30 shown in FIG. 3.

### Variant Embodiments

Although the first exemplary embodiment of the invention and modified examples thereof are explained above, the basic configuration and the scope of the invention is in way limited to any of the above specific embodiment/examples. In the configurations of the ink-jet recording apparatus 10 according to the foregoing first exemplary embodiment of the invention and the modified examples thereof, the ink cartridges 13, which constitute a non-limiting example of a liquid container, are detachably attached to the ink-supply head member 30. However, the scope of the invention is not limited to such an exemplary configuration. For example, an ink tank may be used as the liquid container. Specifically, it is possible to provide an ink tank at a certain off-carriage position that is not over the recording head 11. In such a modified configuration, the liquid container may be connected to the recording head 11 by means of a liquid-supply tube such as an ink-supply tube.

In the configurations of the ink-jet recording apparatus 10 according to the foregoing first exemplary embodiment of the invention and the modified examples thereof, each of the filters 35 are provided either on the upstream surface of the first component member 33 of the ink-supply head member 30 or on the upstream surface of the second component member 34 of the ink-supply head member 30. However, the scope of the invention is not limited to such an exemplary configuration. For example, the filters 35 may be provided either on the downstream surface of the first component member 33 or on the downstream surface of the second component member 34 of the ink-supply head member 30.

In the configurations of the ink-jet recording apparatus 10 according to the foregoing first exemplary embodiment of the invention and the modified examples described above, each of the ink-supply head members 30, 30A, 30B, 30C, and 30D are made up of two split component members, that is, the first component member 33 and the second component member 34. In addition, it is further explained in the foregoing description that the filters 35 are provided on the exposed surface of the ink-supply head member 30, 30A, 30B, 30C, or 30D, at the cartridge attachment portion 31 and the adhesion surface 36 between the first component member 33 and the second component member 34. However the scope of the invention is not limited to such an exemplary configuration. For example, some filters 35 may be formed on the surface of the ink-supply head member 30, 30A, 30B, 30C, or 30D facing the head-body-portion 40. Or, as another non-limiting modification example thereof, the ink-supply head member 30, 30A, 30B, 30C, or 30D may be made up of three or more component members. In such a non-limiting modified configuration, the filters 35 may be formed on the exposed surface of the ink-supply head member 30, 30A, 30B, 30C, or 30D with two adhesion surfaces formed therebetween. That is, the filters 35 may be provided on three or more different surfaces. Needless to say, in this modified configuration, the filters 35 may be formed in the adhesions surfaces between the component members, rather than on the exposed surface of the ink-supply head member 30, 30A, 30B, 30C, or 30D as described above.

In the configurations of the ink-jet recording apparatus 10 according to the foregoing first exemplary embodiment of the invention and the modified examples thereof, the first ink-supply needles 50A and the second ink-supply needles 50B are provided as discrete and individual needles that are separate from each other. However, the scope of the invention is not limited to such an exemplary configuration. For example, a set of the first ink-supply needle(s) 50A and the second ink-supply needle(s) 50B may be formed as a single integrated ink-supply needle member. Such a single integrated ink-supply needle member makes it possible to decrease the needle-adhesion area size that is required for adhering the first ink-supply needles 50A and the second ink-supply needles 50B to the ink-supply head member 30, 30A, 30B, 30C, or 30D. As a result thereof, it is possible to array the filters 35 closer to one another, thereby narrowing inter-filter distances. In addition, it is possible to further reduce the size of the ink-supply head member 30, 30A, 30B, 30C, or 30D.

In the configurations of the ink-jet recording apparatus 10 according to the foregoing first exemplary embodiment of the invention and the modified examples described above and illustrated in FIGS. 3, 6, 7, 8, and 9, adjacent filters that are arrayed in the closest proximity to each other partially overlap each other. However, the scope of the invention is not limited to such an exemplary configuration. For example, the first-ink-supply-passage filters 35 of the first-ink-supply-passage line of filters that are provided on the cartridge attachment portion 31 of the ink-supply head member 30 and the second-ink-supply-passage filters 35 of the second-ink-supply-passage line of filters that are provided on the adhesion surface 36 between the first component member 33 and the second component member 34 may be provided in such a manner that each two adjacent filters that are arrayed in the closest proximity to each other do not overlap each other. This is because the needle-adhesion area that is required for adhering the ink-supply needles 50 to the exposed surface, that is, the cartridge attachment portion 31, of the ink-supply head member 30, 30A, 30B, 30C, or 30D may overlap the second-ink-supply-passage filters 35 of the second-ink-supply-passage line of filters that are provided on the adhesion surface 36 between the first component member 33 and the second component member 34.

In the configurations of the ink-jet recording apparatus 10 according to the foregoing first exemplary embodiment of the invention and the modified examples described above, the first-ink-supply-passage filters 35 of the first-ink-supply-passage line of filters that are provided on the cartridge attachment portion 31 of the ink-supply head member 30 and the second-ink-supply-passage filters 35 of the second-ink-supply-passage line of filters that are provided on the adhesion surface 36 between the first component member 33 and the second component member 34 partially overlap each other. However, the scope of the invention is not limited to such an exemplary configuration. For example, the first-ink-supply-passage filters 35 of the first-ink-supply-passage line of filters that are provided on the cartridge attachment portion 31 of the ink-supply head member 30 may be at the same position as the positions of the second-ink-supply-passage filters 35 of the second-ink-supply-passage line of filters that are provided on the adhesion surface 36 between the first component member 33 and the second component member 34. Such a modified filter array pattern explained above can be adopted if, for example, some of the plurality of ink-supply passages 32 have a bent, curved, or slanted passage structure which avoids any redundant filtering.

In the configurations of the ink-jet recording apparatus 10 according to the foregoing first exemplary embodiment of the invention and the modified examples described above, it is explained that each the plurality of ink-supply passages 32 have a straight ink-communicating flow channel which achieves the shortest distance from the liquid container to the ink-eject head body portion 40. However, the scope of the invention is not limited to such an exemplary configuration. For example, some or all of the plurality of ink-supply passages 32 may have, for example, a bent, curved, or slanted passage structure. That is, the invention can be also applied even in a case where each of the plurality of ink-supply passages 32 does not have a straight ink-communicating flow channel that achieves the shortest distance from the liquid container to the ink-eject head body portion 40.

In the configurations of the ink-jet recording apparatus 10 according to the foregoing first exemplary embodiment of the invention and the modified examples described above, a single ink-eject head body portion 40 is provided for the plurality of ink-supply passages 32. However, the scope of the invention is not limited to such an exemplary configuration. For example, a plurality of ink-eject head body portions 40 may be provided so as to correspond to a set of ink colors. In such a modified configuration, each of the plurality of ink-supply passages 32 may be provided in communication with the corresponding ink-eject head body portions 40. Each of the plurality of ink-supply passages 32 may be provided so as to communicate with the ink-eject head body portion 40 for the corresponding nozzle line. Notwithstanding the foregoing, however, each of the plurality of ink-supply passages 32 may not be in communication therewith on a nozzle-line-by-nozzle-line basis. A single ink-supply passage 32 may be in communication with a plurality of nozzle lines. Or, as another non-limiting example, a single nozzle line may be divided into two groups in such a manner that the ink-supply passage 32 is in communication with each of these two groups of the nozzle lines. That is, the invention is applicable as long as the ink-supply passage 32 is in communication with a nozzle opening group which is comprised of a plurality of nozzle openings.

In the foregoing embodiment of the invention described above, the invention is explained using an ink-jet recording head 11 as a typical example of a liquid ejecting head. Notwithstanding the foregoing, the invention is directed to various kinds of liquid ejecting heads; and therefore, the invention is also applicable to a variety of liquid ejecting heads that eject liquid other than ink. Liquid ejecting heads to which the invention is applicable encompass a wide variety of heads; specifically, they include without any limitation thereto: recording heads that are used in an image recording apparatuses such as printers or the like, color material ejection heads that are used in the production of color filters for liquid crystal display devices or the like, electrode material (i.e., conductive paste) ejection heads that are used for electrode formation for organic EL display devices or surface/plane emission display devices (FED, field emission display) and the like, and in living organic material ejection heads that are used to produce biochips.

What is claimed is:

1. A liquid ejecting head comprising:
a liquid ejecting head body including a plurality of nozzle openings, the liquid ejecting head body being capable of ejecting liquid that is supplied from a liquid container from the plurality of nozzle openings;
a liquid-supply member disposed between the liquid container and the liquid ejecting body, comprised of a first and second separate member which are adhered together, the liquid-supply member having a plurality of liquid-supply passages formed inside the liquid-supply member which penetrate through the first and second separate members of the liquid-supply member, the plurality of liquid-supply passages being capable of transferring the liquid from the liquid container to each group of the plurality of nozzle openings of the liquid ejecting head; and
a plurality of first and second filters provided across the plurality of liquid-supply passages;
wherein the plurality of liquid-supply passages includes a plurality of first liquid-supply passages that have the first filters on the surface of the first separate member and a plurality of second liquid-supply passages that have the second filters on the surface of the second separate member.

2. The liquid ejecting head according to claim 1, wherein the first filters are formed on the upstream surface of the first separate member and the second filters are formed on the upstream surface of the second separate member.

3. The liquid ejecting head according to claim 1, wherein the first filters are formed on the downstream surface of the first separate member and the second filters are formed on the downstream surface of the second separate member.

4. The liquid ejecting head according to claim 1, wherein each of the plurality of liquid-supply passages has a filter chamber with a widened portion that is formed immediately upstream of the filter and at the immediately downstream of the filter, and the filter chamber of each of the first liquid-supply passages has substantially the same shape as that of the filter chamber of each of the second liquid-supply passages.

5. A liquid ejecting head comprising:
a liquid ejecting head body that has a plurality of nozzle openings, the liquid ejecting head body being capable of ejecting liquid supplied from a liquid container from the plurality of nozzle openings;
a liquid-supply member that has a plurality of liquid-supply passages formed inside the liquid-supply member, the plurality of liquid-supply passages being used for communicating the liquid to the liquid ejecting head body; and
a plurality of first and second filters that are provided across the plurality of liquid-supply passages;
wherein the plurality of liquid-supply passages includes first liquid-supply passages which have the first filter provided across the first liquid-supply passage and the second liquid-supply passages have the second filter provided across the second liquid-supply passage, and the first filters provided across the first liquid-supply passages and the second filters provided across the second liquid-supply passages are arrayed in such a manner that the projected area of the first filters overlaps the projected are of the second filters as viewed from the filtering surface, and
wherein the first liquid-supply passages has a first filter chamber including a widened portion of the first liquid-supply passage that is formed immediately upstream of the first filter and at the immediately downstream of the first filter, the second liquid-supply passages has a second filter chamber including a widened portion of the second liquid-supply passage that is formed immediately upstream of the second filter and immediately downstream of the second filter, and the first filter chamber of the first liquid-supply passages has substantially the same shape as that of the second filter chamber of the second liquid-supply passages.

6. A liquid ejecting apparatus that is provided with the liquid ejecting head according to claim 1.

7. A liquid ejecting head comprising:
a liquid ejecting head body capable of ejecting liquid supplied from a liquid container from a plurality of nozzles in the liquid ejecting head body
a liquid-supply member disposed between the liquid container and the liquid ejecting body, comprised of a first and second separate member which are adhered together,
a plurality of first and second liquid-supply passages formed through the first and second separate members of the liquid-supply member, the plurality of first and second liquid-supply passages being capable of transferring the liquid from the liquid container to the nozzles of the liquid ejecting head;
a plurality of first filters provided across the first liquid-supply passages formed across the surface of the first separate member; and
and a plurality of second filters second filters provided across the second liquid-supply passages which are formed across the surface of the second separate member.

8. The liquid ejecting head according to claim 7, wherein the first filters are formed on the upstream surface of the first separate member and the second filters are formed on the upstream surface of the second separate member.

9. The liquid ejecting head according to claim 7, wherein the first filters are formed on the downstream surface of the first separate member and the second filters are formed on the downstream surface of the second separate member.

10. The liquid ejecting head according to claim 7, wherein each of the plurality of liquid-supply passages has a filter chamber with a widened portion that is formed immediately upstream of the filter and at the immediately downstream of the filter, and the filter chamber of each of the first liquid-supply passages has substantially the same shape as that of the filter chamber of each of the second liquid-supply passages.

11. A liquid ejecting apparatus that is provided with the liquid ejecting head according to claim 7.
